(19) United States
(12) Patent Application Publication
(10) Pub. No.: US 2008/0072509 A1
(43) Pub. Date: Mar. 27, 2008

(54) SMALL FOOTPRINT PUBLIC WORKSPACE SYSTEM

(76) Inventor: Mark J. Eberhardt, Racine, WI (US)

Correspondence Address: BOYLE FREDRICKSON S.C., 840 North Plankinton Avenue, MILWAUKEE, WI, 53203, US

(21) Appl. No.: 11/859,322

(22) Filed: Sep. 21, 2007

Related U.S. Application Data
(60) Provisional application No. 60/846,811, filed on Sep. 22, 2006.

(51) Int. Cl. E04H 14/00; A47C 31/00; A61H 1/00

(52) U.S. Cl. 52/239; 297/217.3; 297/217.4; 601/49

(57) ABSTRACT

A workspace system provides for payment units allowing electrical current and other workspace amenities to be purchased, internalizing the costs of electrical charging stations, thereby promoting their use within public spaces.

### CROSS-REFERENCE TO RELATED APPLICATIONS

This application claims the benefit of U.S. provisional application 60/846,811 filed Sep. 22, 2006 hereby incorporated by reference.

### BACKGROUND OF THE INVENTION

The present invention relates to workspaces for travelers and in particular to a compact workspace suitable for airline terminals and the like.

Business travelers are spending increasing amounts of time in airport terminals waiting for connecting flights and immediately before departures, having arrived early to ensure ample time for security check-in procedures. Frequently, such travelers carry with them laptop computers or other electrical devices allowing them to make productive use of this waiting time.

Nevertheless, it can be difficult to accomplish significant amounts of work on a laptop computer or the like in an airport terminal, the latter which can be crowded and distracting. Business travelers may also be reluctant to work on sensitive business documents in the crowded airport seating areas where their screens will be readily visible to other passengers. In addition, business travelers may be reluctant to deplete the charge on their laptop batteries before departure, preferring to retain battery power for work during the flight.

Airports were largely designed without anticipation of the need for recharging laptops. Electrical outlets near seats are typically nonexistent in the airport terminal or may be in locations where extending a cord from the outlet to the seat presents a hazard. While accessible power outlets would be welcomed by business travelers, there is relatively little incentive for the airports to undertake the expense of providing such outlets while incurring additional electrical costs not recaptured by the airport.

Finally, for the traveler recently disembarking from an airplane and waiting for a connecting flight, the concept of sitting for additional time to work with their laptop may seem unattractive. The traveler may be tired and have little recourse but to try to stay awake with coffee or the like at a restaurant.

While some airports have lounges, these are often associated with a particular airline and may not be accessible to any given traveler. Normally the space requirements for a lounge are such as to make them prohibitive except for hub airports.

### SUMMARY OF THE INVENTION

The present invention provides a small footprint workspace system providing an efficient way for travelers to rest and/or work in between flights, while also capturing revenue for the airport, necessary to encouraging placement of the workspace systems in airports. In a preferred embodiment, the workspace system provides a set of seats that may be arranged in a line for maximum space efficiency and privacy. Each seat may incorporate a massage unit to overcome the discomfort associated with sitting for a long period of time and a source of metered electrical power convenient to the user. Headphones playing noise-blocking music or the like may also be provided. The seats may be arrayed along a sound-absorbing privacy wall and/or away from the busy area of the airport to provide a degree of solitude and personal space.

Specifically then, present invention provides a small footprint workspace system for airports and other public spaces, the system having a series of stations, each including an electrical outlet having means for controlling a dispensing of electrical current from the outlet and an associated seating unit for holding a seated user within access of the electrical outlet. A payment unit accepts money from the user of the seating unit to control the electrical outlet to provide a pre-determined access to the electrical current at the seating unit.

Thus it is an object of at least one embodiment of the invention to provide a simple workspace area supported by a vending of electrical power to a user. It is a further object of the invention to provide a market mechanism that encourages the installation of laptop charging stations at public facilities.

The seating units may be arranged in a single line with a back of at least one seating unit arranged to provide a partition in front of at least another one of the seating units. Further, the seating units may be fixed adjacent to a privacy wall on one side of the seating units where the privacy wall and the partitions extend by the height of the seated user.

Thus, it is an object of at least one embodiment of the invention to provide a compact seating system that nevertheless provides a large degree of privacy and isolation to the seated users.

The seating units may include massage units within them controllably providing a massage to the seated user in response to money received by the payment unit.

It is thus another object of at least one embodiment of the invention to provide a workspace that is attractive to a user who may have been sitting for a long period of time in an airplane.

The stations may further include an audio player for playing an audio program to the seated user in response to money received by the payment unit.

It is thus another object of at least one embodiment of the invention to provide a method of blocking airport sound through music or masking noise.

The seat may be reclinable.

It is thus another object of at least one embodiment of the invention to provide a seating unit in which the traveler may obtain some rest before or after working.

The privacy wall and/or partition may include a sound absorbing material.

Thus, it is an object of at least one embodiment of the invention to reduce the acoustic level near the seating units without the need for an enclosure.

These particular objects and advantages may apply to only some embodiments falling within the claims and thus do not define the scope of the invention.

### BRIEF DESCRIPTION OF THE DRAWINGS

FIG. 1 is a perspective side view of the workspace system of the present invention showing two seating units arrayed next to a privacy wall supporting controls accessible to the user; and

FIG. 2 is a block diagram of the controls of FIG. 1 such as includes a payment unit for the receipt of payment and controls for massage, electricity and audio programs for the seated user.

### DETAILED DESCRIPTION OF THE PREFERRED EMBODIMENT

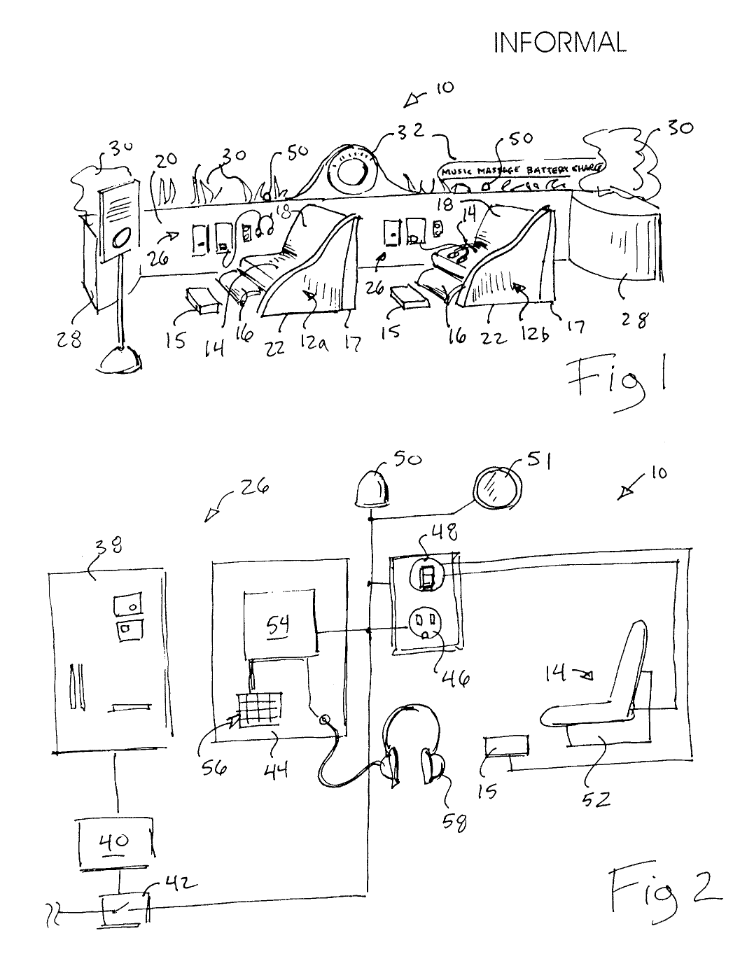

Referring now to FIG. 1, a workspace system 10 may include one or more seating units 12a and 12b, each providing a reclinable massage chair 14, including an upwardly extending footrest 16 and reclining back 18. Massage chairs of this type are well known in the art and commercially available from a number of vendors. The massage chairs 14 may be positioned in a line with one massage chair 14 in front of the other so that the back 18 of the massage chair 14 of the second seating unit 12a provides a partition in front of the user of the massage chair 14 of the second seating unit 12b. An additional separator panel 17 may be positioned at the back of each seating unit 12 to provide an improved definition of the space between the seating units 12.

To the side of both chairs (the right side as depicted) may be a privacy wall 20 against which the massage chairs 14 are placed as held by chair retainer walls 22 on the left side of the massage chairs 14 conforming generally to the profile of the seat and back of the respective massage chair 14.

Ends of the privacy wall 20 in front of the first seating unit 12a and behind the second seating unit 12b may include partial walls 28, extending out therefrom, to further screen users of the first and second seating units 12a and 12b. The top of the privacy wall 20 and the partial walls 28 may provide planters, into which real or artificial plants 30 may be placed to provide additional screening of the seated users. Illuminated signs 32 may be placed on top of the privacy wall 20 describing the services provided by the workspace system 10.

The surfaces of the privacy wall may be an easily cleanable laminate material or wall covering or may be a carpet material to improve sound absorption. Ambient airport lighting will typically provide sufficient illumination, however lighting units (not shown) may also be provided for each seating unit 12a and 12b.

Optional foot massage units 15 may be placed at the foot of each of the massage chairs 14 for use by a person seated in the massage chairs 14.

Referring now also to FIG. 2, the privacy wall 20 supports on its face, for easy accessibility to a user of each seating unit 12a and 12b, a control panel 26. The control panel 26 includes a payment receiving unit 38, for example, a credit card reader and/or bill changer, or other similar device, including for example RFID or Bluetooth payment systems, that may receive credit cards, paper currency or special chits, the latter that have no cash value but may be provided to patrons for use of the workspace system. Henceforth each of these types of payments will be considered money payments. When payment has been received, and according to the amount of payment, a time value is entered into timer 40, for example, being proportionate to the amount of payment received up to a predetermined maximum time.

When the timer 40 is activated, a relay 42 is closed providing line power to an audio unit 44, to an electrical outlet 46, and to a massage chair/foot massage selector switch 48, optional reading light 51, as well as an in-use indicator 50, the latter providing an indication that the seating unit 12 is in use by a paying customer.

The customer may connect their laptop unit to the outlet 46 also positioned for easy access on the privacy wall 20 to charge their laptop and provide for electrical power for other devices. Alternatively or in addition, the user may activate the switch 48 to receive a massage by connecting electrical power to the massage unit 52 of the chair 14 an/or the foot massage unit 15.

The control panel 26 also includes an audio unit 44 that is activated by the timer 40 and that includes a solid-state audio player 54 offering a number of prerecorded selections, such as music, that may be accessed through keypad 56 to provide an audio program through headphones 58 held on the privacy wall 20. The volume of the audio program in the headphones 58 may also be controlled through the keypad 56 and the solid state audio player may also offer non-music selections such as white or pink noise or ambient sounds such as waves or the like as well as noise cancellation features, as well as books on tape, children's stories, foreign language instruction and the like.

It is expected that some users will wish to rest before they work or may wish to use the chair simply for resting. For this purpose, the audio unit 44 may optionally provide for an alarm feature to alert the user to an impending time at which they will want to be ready to board a airplane or the like.

It will be understood that additional features may be provided in or near each seating unit 12 providing added value to the user. For example, a table, stowed in the privacy wall 20 to fold down therefrom, or stored and retrieved from another location, may be provided to support a user's laptop or the like. In one embodiment, the table may unlock or be usable only upon payment being received from the payment receiving unit 38.

The separator panels 17 or similar structure may support a video display in front of each seating unit 12 for the provision of advertising, a captive airport video information channel, cable or broadcast programming, or video games using a self contained video game player or the like, all of the latter activated by payment.

Finally the seating units 12 may provide one or more “call buttons” or a dedicated phone line or the like for the ordering of airport services such as emergency services, assistance for the elderly, or the placing of orders for food or the like from airport vendors. In this way, the user may work uninterrupted while obtaining food and drink.

It is specifically intended that the present invention not be limited to the embodiments and illustrations contained herein, but include modified forms of those embodiments including portions of the embodiments and combinations of elements of different embodiments as come within the scope of the following claims.

What we claim is:

1. A small footprint workspace system for airports and other public spaces comprising:
a series of stations each comprising:
(i) an electrical outlet having means for controlling a dispensing of electrical current from the outlet;
(ii) a seating unit for holding a seated user within access of the electrical outlet;
(iii) at least one payment unit accepting money from the user of the seating unit to control at least one electrical outlet to provide a predetermined access to the electrical current at one seating unit.

2. The workspace system of claim 1 wherein the seating units are arranged in a single line with a back of at least one seating unit providing a partition in front of at least one other seating unit.

3. The workspace system of claim 1 wherein the seating units are fixed adjacent to a privacy wall on one side of the seating units.

4. The workspace system of claim 3 wherein the privacy wall extends by a height of the seated user.

5. The workspace system of claim 1 further including a massage unit within the seating unit for controllably providing a massage to the seated user in response to money received by the payment unit.

6. The workspace system of claim 1 further including an audio player for playing an audio program to the seated user in response to money received by the payment unit.

7. The workspace system of claim 1 wherein the seat is reclinable.

8. The workspace system of claim 1 wherein a privacy wall holds a sound absorbing means.

9. The workspace system of claim 1 further including an in use indicator indicating that payment has been received for an unexpired period of time.

10. A small footprint workspace system for airports and other public spaces comprising:
a seating unit;
an electrical outlet associated with and positioned within reach of a seated user in the seating unit, the electrical outlet having means for controlling a dispensing of electrical current from the outlet; and
a payment unit fixed with respect to the seating unit for access by the seated user to accept money from the user of the seating unit to control the electrical outlet and provide a predetermined access to the electrical current to the seated user.

11. The workspace system of claim 10 further including a massage unit within the seating unit for controllably providing a massage to the seated user in response to money received by the payment unit

12. The workspace system of claim 10 further including an audio player for playing an audio program to the seated user in response to money received by the payment unit.

13. The workspace system of claim 10 wherein the payment unit is a credit card accepting mechanism.

14. The workspace system of claim 10 wherein the payment unit is a bill changer.

15. The workspace system of claim 10 wherein the seat is reclinable.

16. The workspace system of claim 10 further including a privacy wall attached to one side of the seating unit.

17. The workspace system of claim 16 wherein the privacy wall extends by a height of the seated user.

18. The workspace system of claim 10 wherein the privacy wall holds a sound absorbing means.

19. The workspace system of claim 10 further including an in use indicator indicating that payment has been received for an unexpired period of time.
